(19) United States
(12) Patent Application Publication
(10) Pub. No.: US 2007/0215757 A1
(43) Pub. Date: Sep. 20, 2007

(54) Vibration-Insulation Fasteners for Elongated Components

(76) Inventor: Kiyoteru Yuta, Toyohashi-shi (JP)

Correspondence Address: MILES & STOCKBRIDGE PC, 1751 PINNACLE DRIVE, SUITE 500, MCLEAN, VA, 22102-3833, US

(21) Appl. No.: 11/680,256

(22) Filed: Feb. 28, 2007

(30) Foreign Application Priority Data
Feb. 28, 2006 (JP) 2006-053427

(51) Int. Cl. F16L 3/22

(52) U.S. Cl. 248/68.1

(57) ABSTRACT

An integrally molded vibration-insulation plastic fastener comprises a base and a pair of clamps. Each clamp has a U-shaped receiving member with an opening into which an elongated component can be inserted to be held in the clamp. The openings of the U-shaped receiving members of the respective clamps face in different directions. Each clamp has a hinged cover moveable between an open position and a closed position at which the cover closes a corresponding opening. Each U-shaped receiving member is spaced from a corresponding base part except at predetermined regions where the receiving member is connected to the corresponding base part. In some embodiments protrusions are provided in space between the U-shaped receiving member and the corresponding base part.

### CROSS-REFERENCE TO RELATED APPLICATION

This application claims the benefit of Japanese Patent Application No. 2006-053427 filed Feb. 28, 2006, incorporated herein by reference.

### BACKGROUND OF THE INVENTION

This invention relates to integrally molded plastic vibration-insulation fasteners for holding elongated components, such as a pipe or a wire harness, so as to fix the elongated components to a workpiece, such as an automobile body, and is more particularly concerned with reducing vibration transmission between the elongated components and/or between the elongated components and the workpiece.

Various types of fasteners are known for fixing elongated components to a workpiece, while reducing vibration transmission. U.S. Pat. No. 4,881,705 (Patent Publication 1) and U.S. Published Application No. 2004-0251386 (Patent Publication 2) disclose examples of vibration-insulation fasteners for fixing elongated components to a workpiece, in which a soft material in a component-receiving clamp is used to reduce transmission of vibration. European Patent Application EP 0838626A (Patent Publication 3) and PCT Published Application WO99/28663 (Patent Publication 4) disclose other types of vibration-damped fasteners for elongated components.

In fasteners that rely on soft material for vibration damping the soft material reduces the ability of the fastener to maintain elongated components securely, and this failing becomes more severe as the amount of the soft material is increased to provide additional vibration damping. Other types of fasteners for elongated components which do not rely upon soft materials for vibration damping have their own deficiencies, such as complexity in manufacture and use and inadequate vibration damping.

### BRIEF DESCRIPTION OF THE INVENTION

The present invention provides vibration-insulation fasteners that are easily manufactured of integrally molded plastic, that are easy to use even in cramped environments, that can accommodate a plurality of elongated components, and that provide adequate vibration damping without the use of soft materials, so that elongated components can be securely held.

In a preferred configuration in accordance with the invention, an integrally molded plastic fastener comprises a base and a pair of clamps. Each clamp has a U-shaped receiving member with an opening into which an elongated component is inserted, and the respective openings face in different directions. Each clamp has a hinged cover moveable from an open position to a closed position in which an opening in a corresponding U-shaped receiving member is closed to hold an elongated component in place. Each U-shaped holding member is spaced from a corresponding base part except at predetermined regions where the U-shaped receiving member is connected to the corresponding base part. Spaces between each U-shaped receiving member and the corresponding base part are empty but may contain different types of protrusions.

### BRIEF DESCRIPTION OF THE DRAWINGS

The invention will be further described in conjunction with the accompanying drawings, which illustrate preferred (best mode) embodiments, wherein:

FIG. 1 is a perspective view showing a vibration-insulation fastener according to a first embodiment of the present invention.

FIG. 2 is a top plan view showing the vibration-insulation fastener in FIG. 1.

FIG. 3 is a front view showing the vibration-insulation fastener in FIG. 1.

FIG. 4 is a left side view showing the vibration-insulation fastener in FIG. 1.

FIG. 5 is a bottom view showing the vibration-insulation fastener in FIG. 1.

FIG. 6 is a sectional view showing the vibration-insulation fastener, taken along the line A-A in FIG. 2.

FIG. 7 is a front view showing the vibration-insulation fastener in FIG. 1, in a state after holding a pipe

FIG. 8 is a perspective view showing a vibration-insulation fastener according to a second embodiment of the present invention.

FIG. 9 is a front view showing the vibration-insulation fastener in FIG. 8.

FIG. 10 is a sectional view showing the vibration-insulation fastener in FIG. 8.

FIG. 11 is a front view showing the vibration-insulation fastener in FIG. 8, in a state after holding a pipe

FIG. 12 is a perspective view showing a vibration-insulation fastener according to a third embodiment of the present invention.

FIG. 13 is a front view showing the vibration-insulation fastener in FIG. 12.

FIG. 14 is a sectional view showing the vibration-insulation fastener in FIG. 12.

FIG. 15 is a front view showing the vibration-insulation fastener in FIG. 12, in a state after holding a pipe

FIG. 16 is a perspective view showing a vibration-insulation fastener according to a fourth embodiment of the present invention.

FIG. 17 is a front view showing the vibration-insulation fastener in FIG. 16.

FIG. 18 is a sectional view showing the vibration-insulation fastener in FIG. 16.

FIG. 19 is a front view showing the vibration-insulation fastener in FIG. 16, in a state after holding a pipe

FIG. 20 is a perspective view showing a vibration-insulation fastener according to a fifth embodiment of the present invention.

FIG. 21 is a front view showing the vibration-insulation fastener in FIG. 20.

FIG. 21 is a sectional view showing the vibration-insulation fastener in FIG. 20.

FIG. 23 is a front view showing the vibration-insulation fastener in FIG. 20, in a state after holding a pipe

FIG. 24 is a perspective view showing a vibration-insulation fastener according to a sixth embodiment of the present invention.

FIG. 25 is a front view showing the vibration-insulation fastener in FIG. 24.

FIG. 26 is a sectional view showing the vibration-insulation fastener in FIG. 24.

FIG. 27 is a front view showing the vibration-insulation fastener in FIG. 24, in a state after holding a pipe

### DETAILED DESCRIPTION OF THE INVENTION

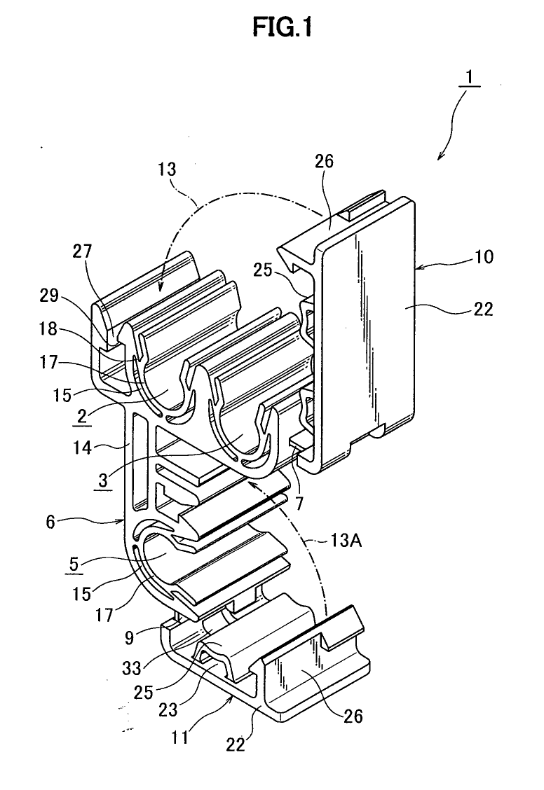

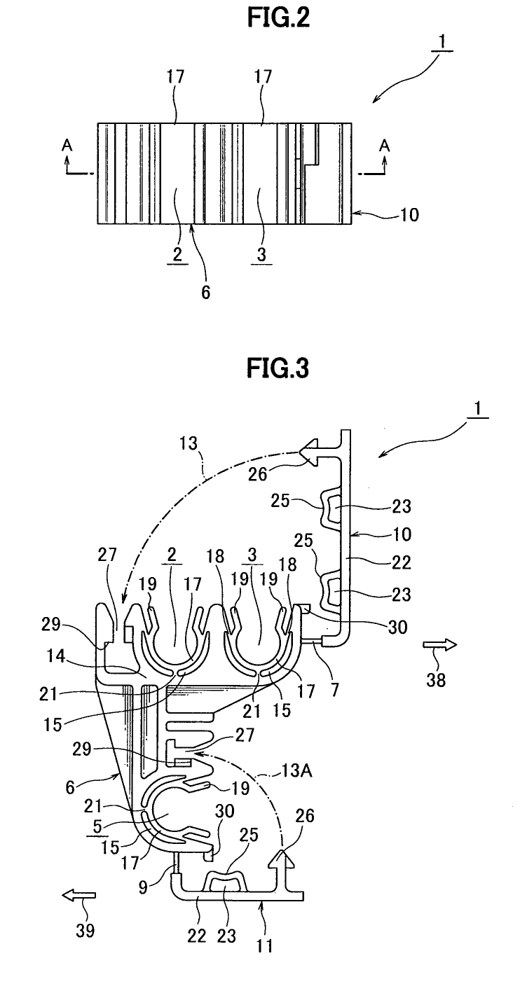

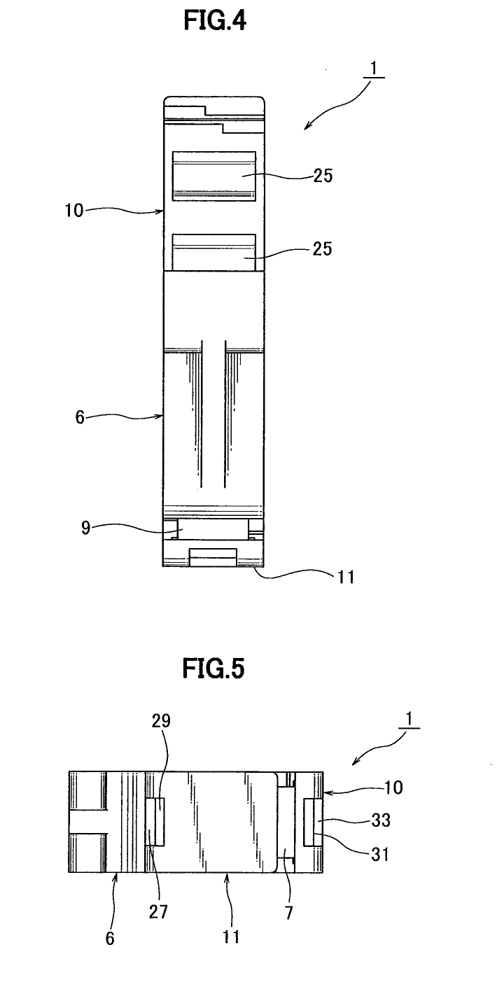

With reference to the drawings, a plurality of embodiments of the present invention will now be described. A vibration-insulation fastener 1 according to a first embodiment of the present invention is designed to hold an elongated component such as a pipe, for example, a fuel pipe or a brake oil pipe, or a wire harness. This vibration-insulation fastener 1 for a pipe or the like will be described with reference to FIGS. 1 to 7. The vibration-insulation fastener 1 comprises: a base 6 having two U-shaped first clamps 2, 3 and a U-shaped second clamp 5 each formed to hold an elongated component, such as a pipe; a first cover 10 connected to the base 6 through a first hinge 7 to close respective openings of the first clamps 2, 3; and a second cover 11 connected to the base 6 through a second hinge 9 to close an opening of the second clamp 5. The base 6, the first and second hinges 7, 9 and the first and second covers 10, 11 of the vibration-insulation fastener 1 are integrally formed in one piece through an integral molding process using a hard plastic material. The base 6 has a wall thickness greater that that of the remaining elements so as to allow a rigidity of vibration-insulation fastener 1 to be maintained.

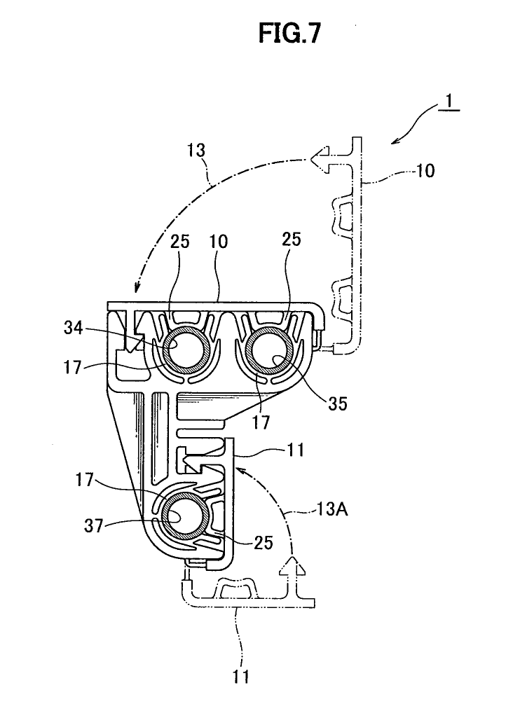

On the base 6, the second clamp 5 is formed at a position apart from the two first clamps 2, 3. The first cover 10 is associated with the first clamps 2, 3 through the first hinge 7, and the second cover 11 is associated with the second clamp 5 through the second hinge 9. The first cover 10 is formed to be pivotally moved in a first swing direction 13 about the first hinge 7 during an operation of closing the first clamps 2, 3, and the second cover 11 is formed to be pivotally moved in a first swing direction 13A about the second hinge 9 during an operation of closing the second clamp 5. That is, the two covers 10, 11 are moved in a common swing direction (e.g., clockwise or counter-clockwise). Each cover is moveable between an open position (shown in FIGS. 1 and 3, for example) and a closed position (shown in FIG. 7, for example). Preferably, each of the hinges 7, 9 is formed as a plate-shaped member having a thin wall and a width less than that of the cover to avoid hindering the swing movement for opening and closing the cover. The number of the first clamps or the number of the second clamps is not limited to this embodiment, but any desired number, such as one, or two or more, may be selected.

The first clamps 2, 3 are arranged to extend in parallel relation to each other so as to hold two pipes in parallel, and the second clamp 5 is arranged at a position apart from the first clamps 2, 3 in a direction perpendicular to the parallel arrangement direction of the first clamps 2, 3. The opening of the second clamp 5 is oriented to face in a direction perpendicular to a facing direction of the openings of the first clamps 2, 3. The two types of openings oriented in different directions allow a plurality of pipes (in this embodiment, three) to be fastened to each other. These pipes can be easily fastened through an operation of holding the pipes in the respective clamps 2, 3, 5 and then pivotally moving each of the first cover 10 and the second cover 11 in a closing direction which is the common-swing direction.

Each of the first clamps 2, 3 and the second clamp 5 includes a U-shaped receiving member 17 which is spaced apart from a corresponding base part 14 to define a space 15 therebetween, empty except at predetermined spaced regions, namely, at respective opposite end regions 18 and a bottom or central region 21 in the U-shape thereof, where the receiving members are connected to the base body parts. In this way, each of the receiving members 17 is disposed spaced apart from the corresponding base part 14 except for the vicinities of the ends and the bottom in the U-shape. Thus, a vibration transmission area between each receiving member 17 and the base 6 is drastically reduced to provide a significant effect of blocking the vibration transmission between the receiving member 17 and the base.

Preferably, each receiving member 17 is formed to minimize its wall thickness, but only to an extent that it can still have sufficient strength for holding a pipe. As illustrated in the figures, a connection portion 18 at each of the vicinities of the ends of each receiving member 17 is formed as a thin-walled resilient portion extending obliquely toward the corresponding base part 14 to provide resilience to the receiving member 17. Thus the receiving member 17 has a vibration absorbing function so as to enhance the vibration-insulation effect.

A portion of each receiving member located on an outward side of the connection portion 18 at each of the vicinities of the ends in the U-shape has splayed walls forming a resilient tapered guide 19 extending outwardly to facilitate insertion of an elongated component. A connection portion 21 at the bottom of the U-shaped receiving member 17 has rigidity to allow an elongated component received in the receiving member 17 to be held at a given position and in a given posture within the clamp, and contributes to maintaining the position and posture of the component.

Each of the first cover 10 and the second cover 11 has a pressing member 25 at a position corresponding to each of the openings of the clamps, protruding outward from a body 22 of the cover and surrounding an empty space 23. The pressing member 25 is formed as a thin U-shaped resilient wall with legs obliquely connected to the cover body 22 to resiliently press an elongated component held in a clamp. Each of the pressing members 25 of the covers allows a component received in a corresponding one of the clamps to be reliably held in the clamp. A portion of the pressing member 25 to be in contact with a component is spaced apart from the cover body 22 by an empty space 23 defined therebetween. This makes it possible to drastically reduce vibration transmission area between the pressing member 25 and the cover body 22 and to provide resilient vibration absorption so as to obtain an excellent vibration-transmission blocking effect.

Each of the first cover 10 and the second cover 11 has one end opposite to the hinge 7 or 9 formed with a lock pawl 26 for keeping the cover at its closed position. The base 6 is formed with a lock-pawl receiving hole 27 and a lock-pole latch shoulder 29 at a position corresponding to the lock pawl 26. Further, the covers 10, 11 and the base have a structure for allowing each of the covers to be kept at its closed position even if the associated hinge is broken. Specifically, each of the first cover 10 and the second cover 11 is formed with a depression 33 (FIG. 5) having an engagement portion 31 at a position adjacent to a corresponding one of the first hinge 7 and the second hinge 9. Further, the base 6 is formed with a protrusion 30 (FIG. 3) for keeping the cover at the closed position, at a position corresponding to the depression 33 when the cover is closed. Thus, when the cover is closed, the protrusion 30 is received in the depression 33 and engaged with the engagement portion 31. Even if the thin-walled hinge is broken after an elongated component is fastened to the clamp, the held state of the elongated component in the clamp will be maintained based on the engagement between the protrusion 30 and the engagement portion 31 of the depression 33.

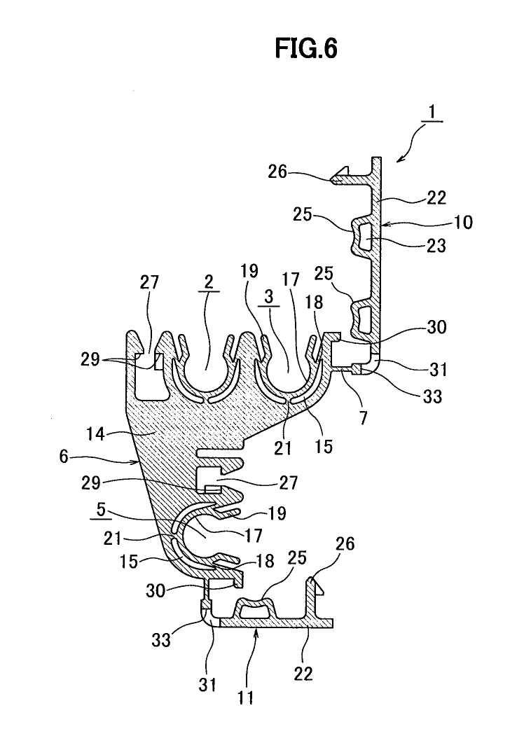

FIG. 7 shows a state after pipes 34, 35, 37 are held to each other by using the vibration-insulation fastener 1. The pipes 34, 35 are held in the vibration-insulation fastener 1 by fitting the pipes 34, 35 in the first clamps 2, 3, and pivotally moving the first cover 10 in the first swing direction 13 to insert the lock pawl 26 into the lock-pawl receiving hole 27. In the same manner, the pipe 37 is held in the vibration-insulation fastener 1 by putting the pipe 37 in the second clamp 5, and pivotally moving the second cover 11 in the first swing direction 13A to insert the lock pawl 26 into the lock-pawl receiving hole 27. See FIGS. 6 and 7. Each of the pipes 34, 35, 37 is held within a clamp by a receiving member 17 and a pressing member 25 of the cover. Thus, a high holding force can be maintained while keeping the vibration-insulation function at a high level. By virtue of the construction of the fastener of the invention, a fastening operation is easily performed even in a narrow work space. In a detaching operation the lock-pawls 26 are disengaged from the lock-pawl latch shoulders 29 using a tool, such as a screw driver, and then each cover is pivotally moved in an opening direction. The pipes can then be easily detached.

While the vibration-insulation fastener 1 can be manufactured at low cost in an integral molding process using a hard plastic material, in designing split molds in an integral molding process for forming the vibration-insulation fastener 1, it is necessary to provide two slides sliding in split molds, respectively, in two directions, as indicated by thick arrows 38, 39 in FIG. 3, due to the respective face directions and postures of the first cover 10 and the second cover 11.

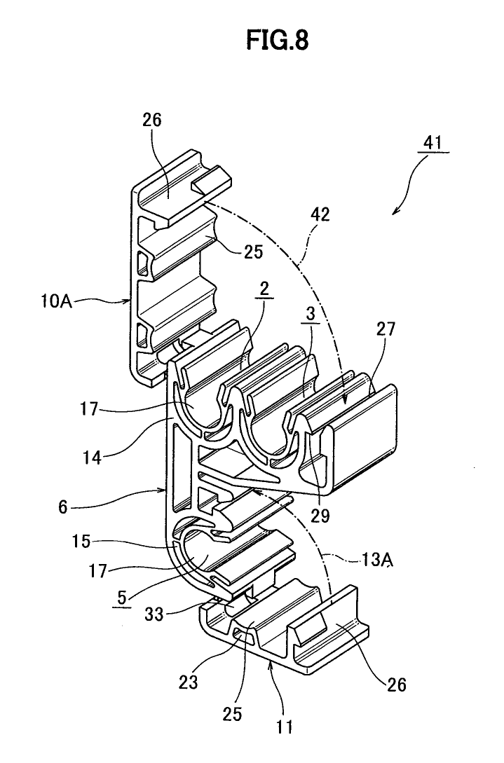

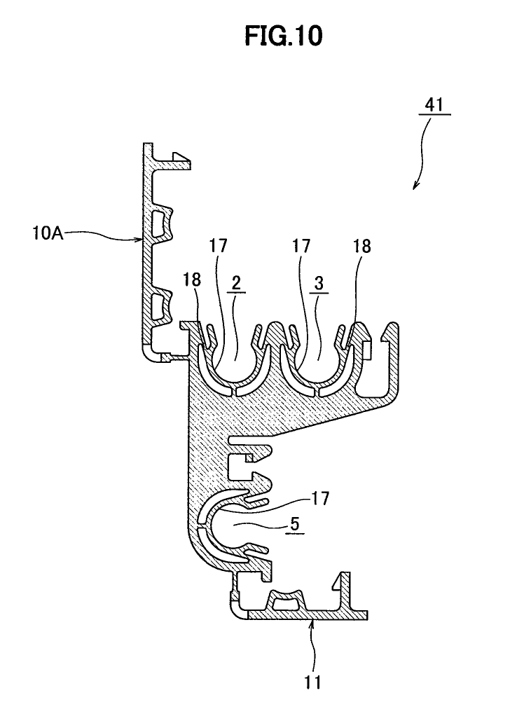

With reference to FIGS. 8 to 11, a vibration-insulation fastener 41 according to a second embodiment of the present invention will be described, which permits the use of a single slide. The vibration-insulation fastener 41 has a number of common features with the vibration-insulation fastener 1. Thus, a description of features in common with the vibration-insulation fastener 1 will be omitted.

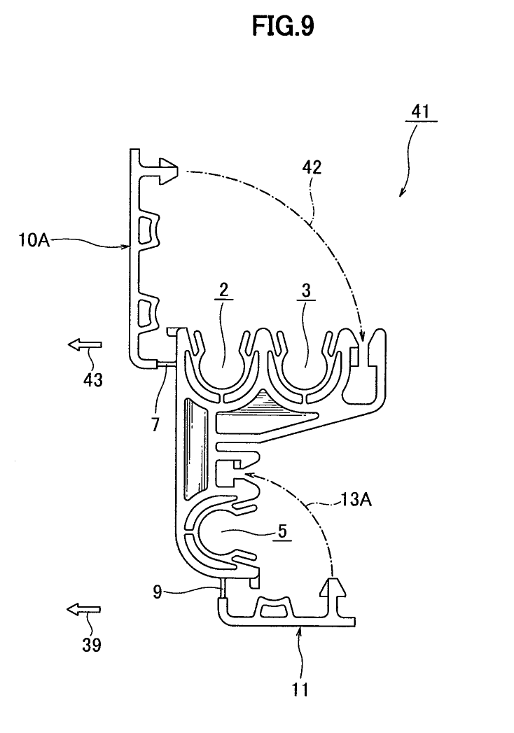

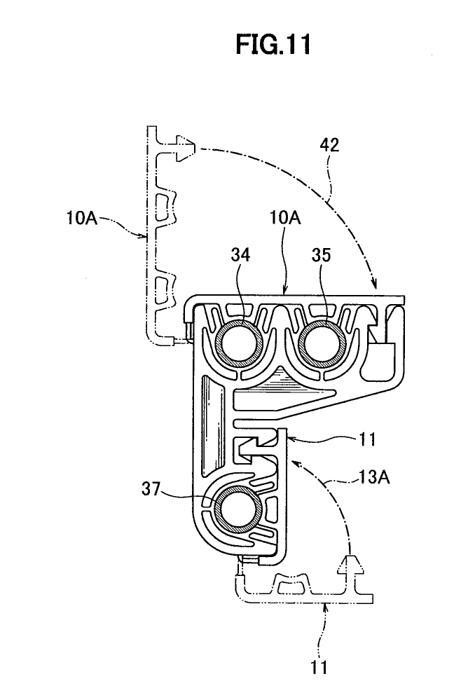

In the vibration-insulation fastener 41, a first cover 10A is connected to the base 6 through the first hinge 7 in such a manner as to have a swing direction opposite to that of the first cover 10 of the vibration-insulation fastener 1. The remaining structure is the same as that of the vibration-insulation fastener 1, and its description will be omitted. When the first cover 10A is closed to cover the first clamps 2, 3, it is pivotally moved in one direction (arrow 42) about the first hinge 7. As described in the first embodiment, the second cover 11 is pivotally moved about the second hinge 9 in a direction (arrow 13A) opposite to the arrowed direction 42 when it is closed to cover the second clamp 5. In this case, a relationship between respective face directions of the first cover 10A and the second cover 11 is different from that in the vibration-insulation fastener 1. This is advantageous in that, during an operation of opening split molds for the vibration-insulation fastener 41, one side slides can be used in the split molds as indicated by thick arrows 39, 43 in FIG. 9. Thus, the vibration-insulation fastener 41 can be offered at lower cost. FIG. 11 shows a state after the pipes 34, 35, 37 are held to each other by using the vibration-insulation fastener 41.

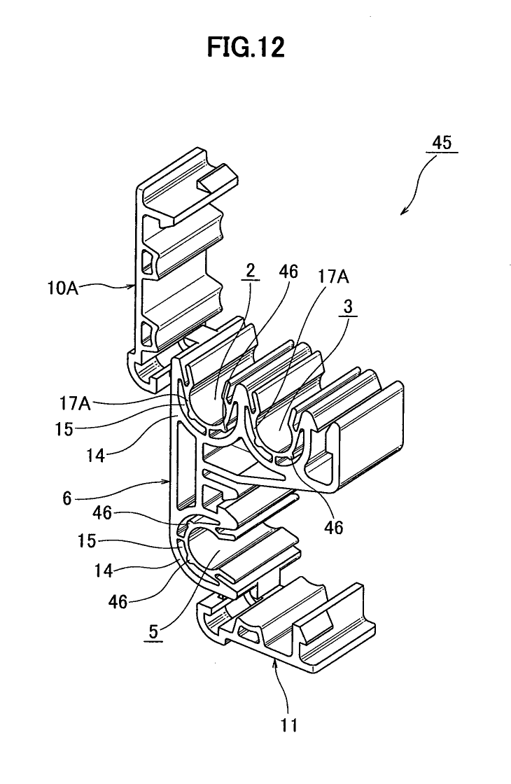

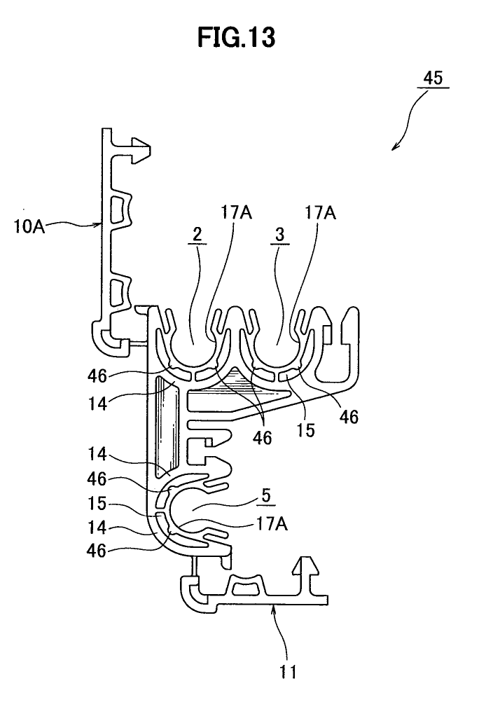

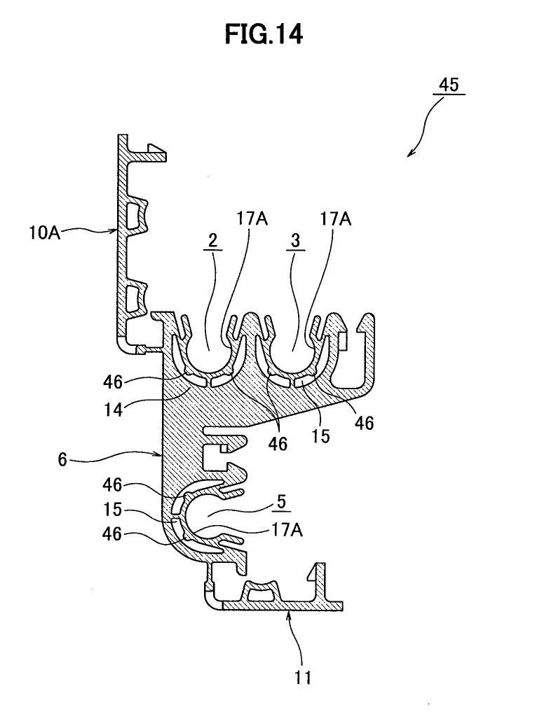

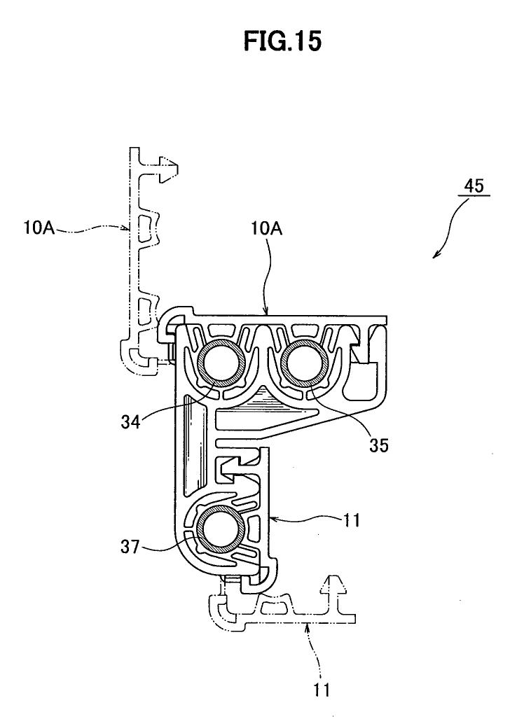

With reference to FIGS. 12 to 15, a vibration-insulation fastener 45 according to a third embodiment of the present invention will be described. The vibration-insulation fastener 45 has a number of common features with the vibration-insulation fastener 1. A description of those features will be omitted. Further, a first cover 10A is the same as that in the vibration-insulation fastener 41 according to the second embodiment, and its description will be omitted.

In the vibration-insulation fastener 45, a receiving member 17A in each of the clamps 2, 3, 5 is formed with raised portions (protrusions) 46 extending into the space 15 defined between the receiving member 17A and the corresponding base part 14, at a position facing the base part. While the receiving member 17A may be moved in a radial direction when an elongated component, such as a pipe, is moved within the clamp in the radial direction, the raised portions 46 can restrict the radial movement of the receiving member 17A to maintain a posture of the elongated component held in the clamp without wobbling.

As shown in FIGS. 12 to 14, the U-shaped receiving member 17A may have two raised portions 46 at respective intermediate positions between the bottom and one of the ends in the U shape thereof and between the bottom and the other end. The number and shape of the raised portions may vary. FIG. 15 shows a state after pipes 34, 35, 37 are held to each others by using the vibration-insulation fastener 45.

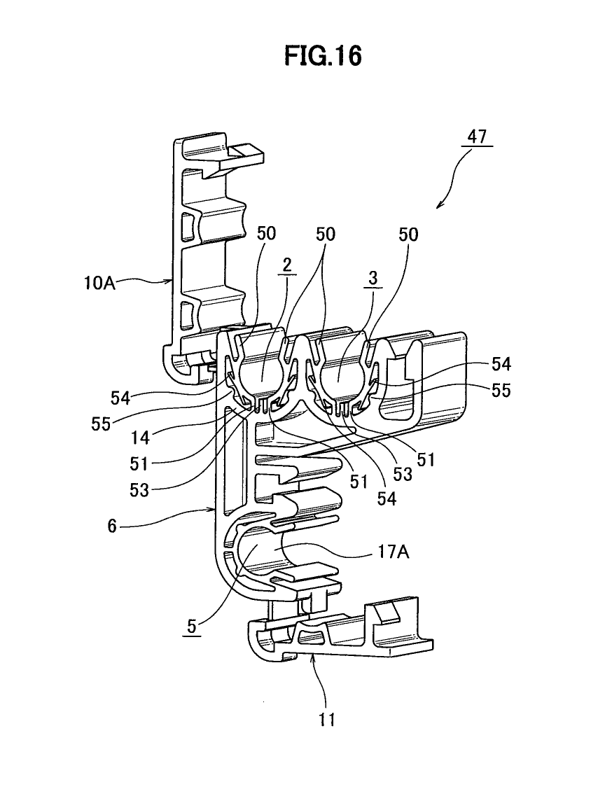

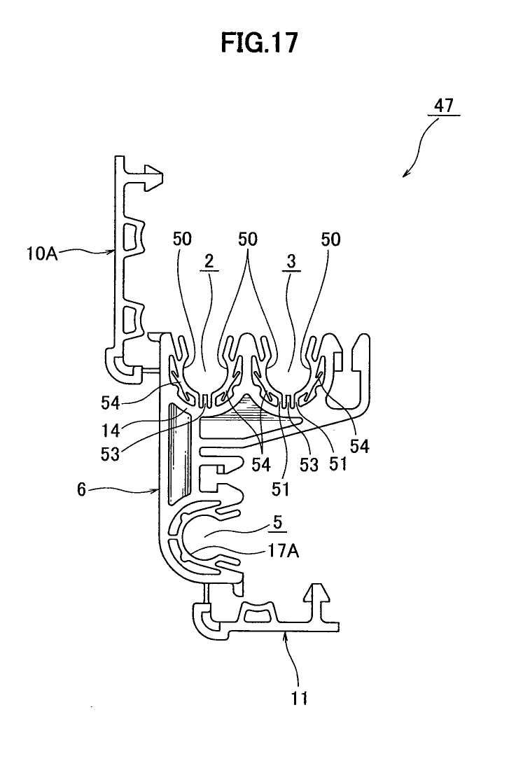

With reference to FIGS. 16 to 19, a vibration-insulation fastener 47 according to a fourth embodiment of the present invention will be described. The vibration-insulation fastener 47 has a number of common features with the vibration-insulation fastener 1. As to such features, refer to the description of the vibration-insulation fastener 1. Further, a first cover 10A is the same as that in the vibration-insulation fastener 41 according to the second embodiment, and its description will be omitted. A receiving member 17A in the second clamp 5 is the same as that in the vibration-insulation fastener 45 according to the third embodiment, and its description will be omitted.

In the vibration-insulation fastener 47, a U-shaped receiving member in each of the clamps 2, 3 is bifurcated to form partial receiving members 50 spaced at a bottom of the U-shape. The bottom of each partial receiving member 50 is connected to the corresponding base part 14 through two spaced-apart connection portions 51. The base part 14 is formed with a projection 53 protruding into a space between the two connection portions 51 in side-by-side relation to the connection portions 51, to support an elongated component. Each of the connection portions 51 has a thin wall thickness and extends from the base part 14 up to a given height so as to provide, to a corresponding one of the partial receiving members 50, resilience allowing the partial receiving members to be bent in a radially outward direction. This resilience provides enhanced vibration-insulation effect. The projection 53 protruding between the two connection portions 51 can prevent an elongated component received in the clamp from being bent in the radially outward direction, so as to maintain a position and posture of the elongated component.

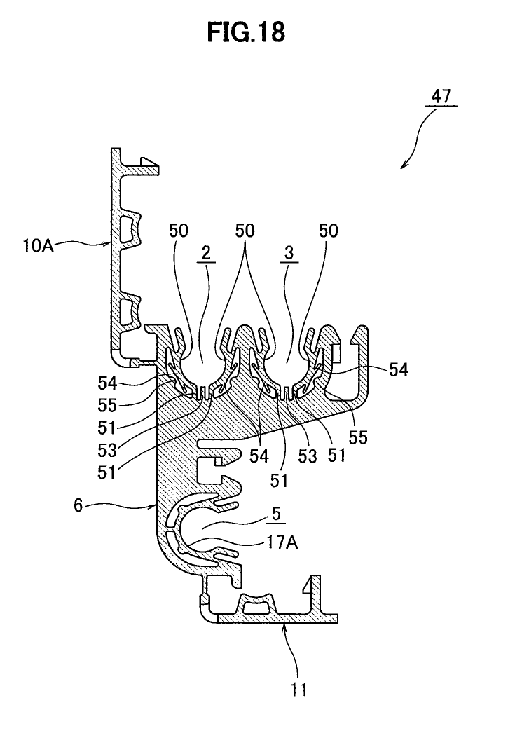

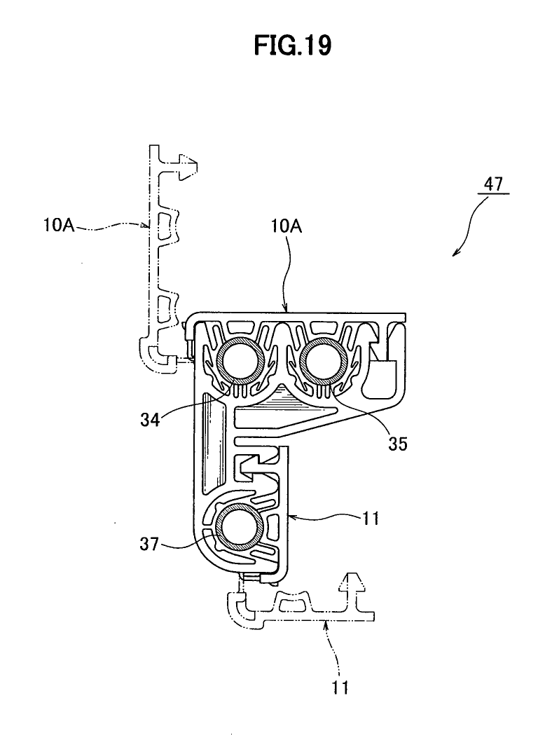

In the vibration-insulation fastener 47, each partial receiving member 50 in each of the clamps 2, 3 is formed with raised portions 54 different from the raised portion 46 of the vibration-insulation fastener 45 according to the third embodiment. Each raised portion 54 has a T-shape cross-section slightly protruding toward the corresponding base part 14 and having arms extending from a stem resiliently along a peripheral surface of the partial receiving member 50 to distal ends. This makes it possible to apply a reaction force to the partial receiving member 50 with enhanced resilience, so as to obtain further enhanced vibration absorbing function. Preferably, each base part 14 is formed with a second raised portion 55 (FIG. 18) at a position intermediate the T-shaped raised portion 54. The second raised portion 55 can restrict a radially outward bending of the partial receiving member 50. FIG. 19 shows a state after pipes 34, 35, 37 are held to each others by using the vibration-insulation fastener 47.

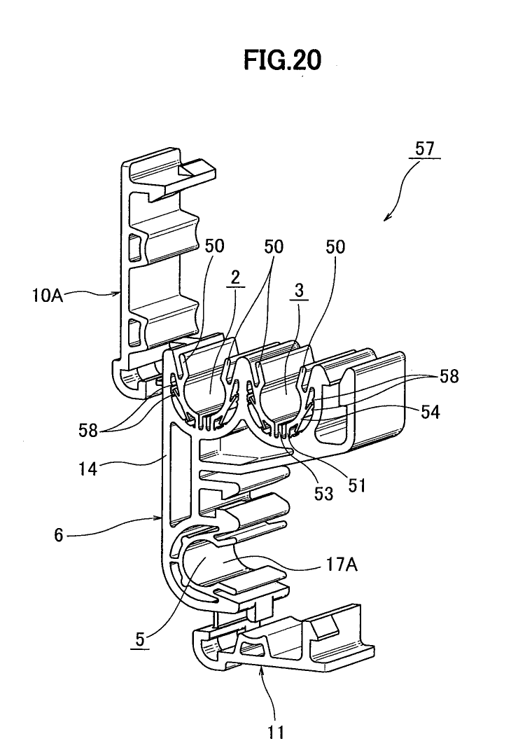

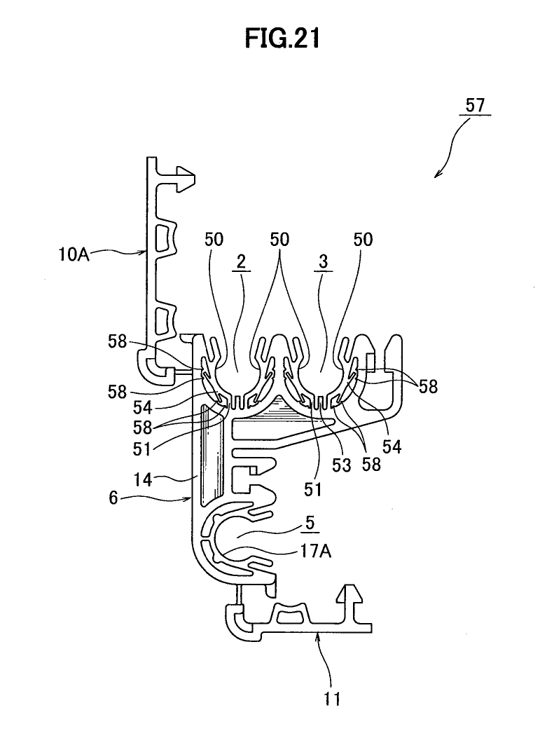

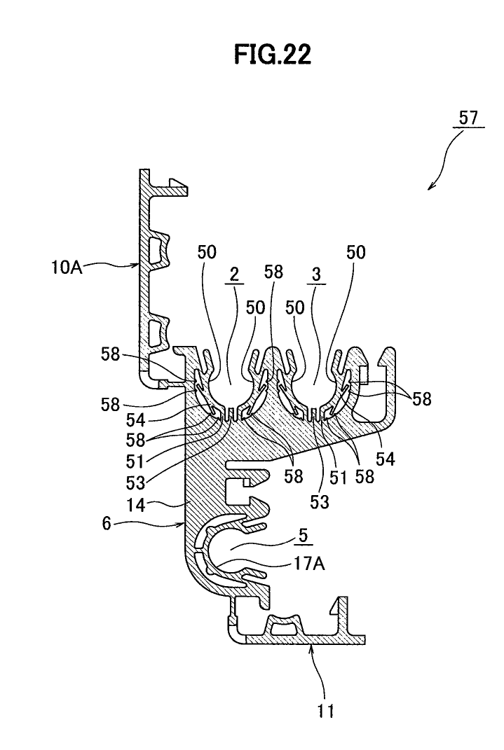

With reference to FIGS. 20 to 23, a vibration-insulation fastener 57 according to a fifth embodiment of the present invention will be described. The vibration-insulation fastener 57 has a number of features common with the vibration-insulation fastener 1. As to such, refer to the description of the vibration-insulation fastener 1. Further, a first cover 10A is the same as that in the vibration-insulation fastener 41 according to the second embodiment, and its description will be omitted. A receiving member 17A in the second clamp 5 is the same as that in the vibration-insulation fastener 45 according to the third embodiment, and its description will be omitted. Partial receiving members 50, two connection portions 51 and T-shaped raised portions 54, are the same as those in the vibration-insulation fastener 47 according to the fourth embodiment, and their description will be omitted.

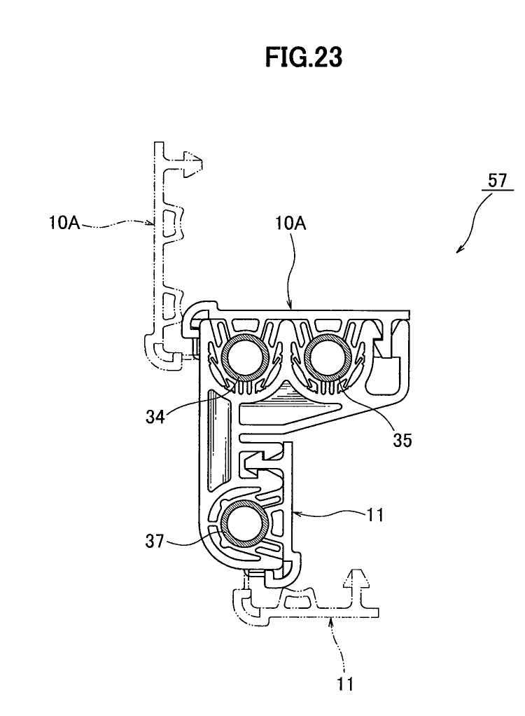

In the vibration-insulation fastener 57, the second raised portion 55 in the vibration-insulation fastener 47 according to the fourth embodiment is not formed in the base part 14 intermediate the T-shaped raised portion 54. Instead, raised portions 58 at positions corresponding to each of the distal ends of the T-shaped raised portion 54 are provided, so as to prevent excessive deformation of the partial receiving members 50, and prevent deformation of the connection portions 51. FIG. 23 shows a state after pipes 34, 35, 37 are held and coupled to each other using the vibration-insulation fastener 57.

In all of the aforementioned vibration-insulation fasteners 1, 41, 45, 47, 57, the base 6 is not provided with an anchor portion for connection to a workpiece, such as an automobile body. Thus, as shown in FIGS. 7, 11, 15, 19 and 23, the pipes 34, 35, 37 are held by the vibration-insulation fastener and mutually coupled in the air. This makes it possible to prevent mutual vibration transmission between the pipes 34, 35, 37. Other structures (not shown) may provide connection to a workpiece.

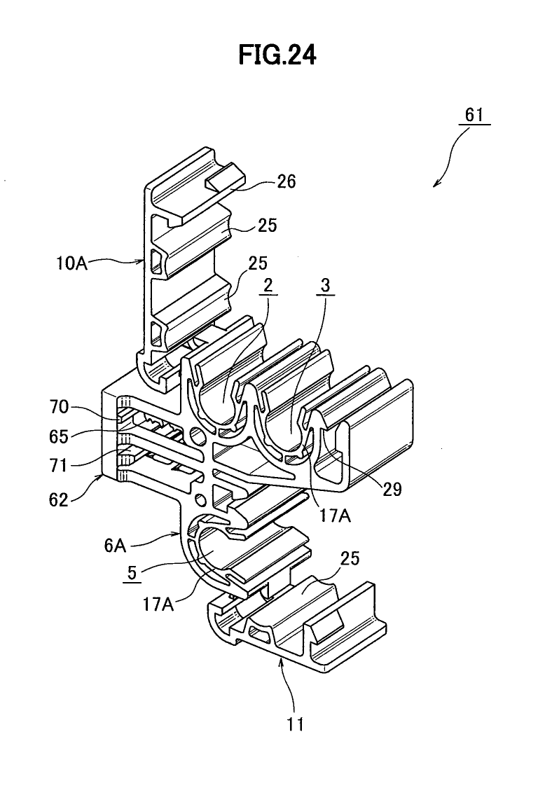

With reference to FIGS. 24 to 27, a vibration-insulation fastener 61 according to a sixth embodiment of the present invention will be described. The vibration-insulation fastener 61 has a base 6A formed with a stud receiving portion 62 for connection to a workpiece, such as an automobile body. The remaining structure, other than the stud receiving portion 62, may be any of the structures of the vibration-insulation fasteners 1, 41, 45, 47, 57. In the illustrated embodiment, the structure of the vibration-insulation fastener 41 according to the second embodiment is employed as the remaining structure, only for the sake of simplicity in explanation. As to the structure other than the stud receiving portion 62, refer to the description of the corresponding structure in the vibration-insulation fastener 1 according to the first embodiment and the vibration-insulation fastener 41 according to the second embodiment. While a stud receiving portion is employed in the illustrated embodiment, any other suitable mounting structure, such as an anchor leg-shaped anchor portion adapted to be inserted into a mounting hole of a workpiece, may be employed.

In the vibration-insulation fastener 61, the stud receiving portion 62 is formed in the base 6A and is adapted to engageably receive therein a rod-shaped stud, such as a threaded stud or a grooved stud (stud with peripheral groove), fixed on a workpiece, such as an automobile body, so as to fasten the vibration-insulation fastener 61 to the workpiece. Thus, the vibration-insulation fastener 61 can fix elongated components, such as a pipe, to the workpiece, while preventing vibration transmission not only between the elongated components but also between elongated components and the workpiece.

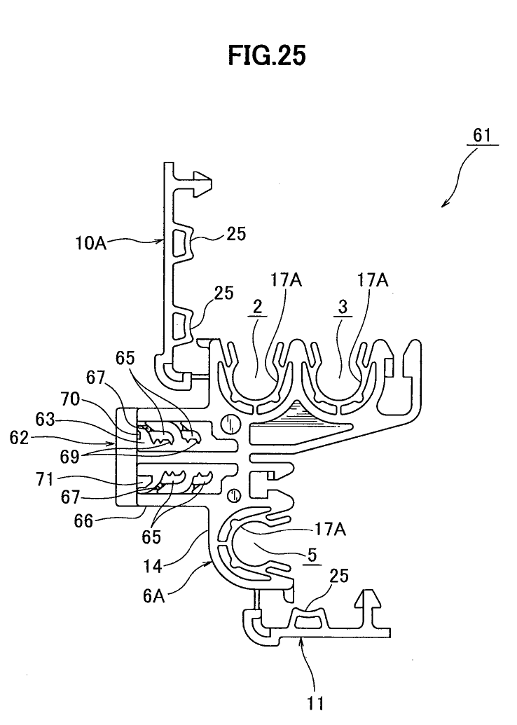

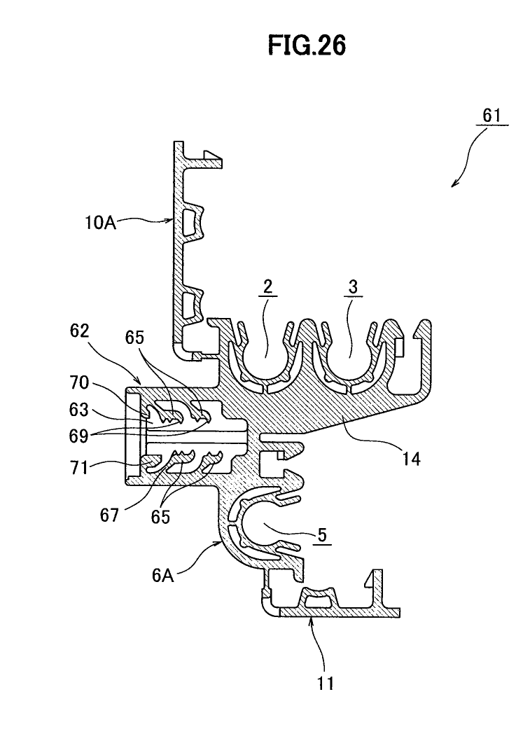

The stud receiving portion 62 of the vibration-insulation fastener 61 is formed with a stud receiving bore 63 which has a pair of latch pawls 65 disposed opposed to each other in a diametrical direction of a stud and adapted to engage with a thread or groove of the stud. In the illustrated embodiment, the stud receiving bore 63 is formed, with, but is not limited to, two sets of the latch pawl pairs 65 arranged along an axial direction of the stud. Each of the latch pawls 65 has an elongated plate shape extending in a direction perpendicular to the drawing sheets of FIGS. 25 and 26. Each of the latch pawls 65 is supported by a thin-walled resilient arm 67 extending from a body 66 of the stud receiving portion. Further, each of the latch pawls 65 has a plurality of pawl edges 69 formed along the axial direction of the stud at certain intervals. Each of the pair of opposed latch pawls 65 is arranged to have a different height in the axial direction of the stud. With this structure, the stud receiving portion 62 can cope with plural types of threaded studs or grooved studs having different pitches, based on the pawl edges 69 of the latch pawls 65 which are engageable with such threads or grooves. In an operation in which the vibration-insulation fastener 61 is pushed to receive a stud therein, the resilient arms 67 allow an operator to perform the pushing operation reasonably without a strong force and without ergonomic problems. The above structure of the stud receiving portion 62 makes it possible to perform the pushing operation by a force of 30 N or less in a one-handed manner.

In the above structure, each of the latch pawls 65 is connected to the body 66 of the stud receiving portion through a resilient arm 67. Thus, the resilient arms 67 can carry out an additional vibration absorbing function to provide further reduced vibration transmission between a workpiece and an elongated component, such as a pipe, held in the clamp, and to obtain a vibration-insulation effect at a higher level.

Further, when an external force is applied in a direction causing pullout of the vibration-insulation fastener 61 from a stud of a workpiece, the resilient arm 67 is resiliently bent, and thereby the pullout blocking function of the latch pawl 65 lowered. However, the stud receiving portion 62 of the vibration-insulation fastener 61 is formed with a pair of blocks 70, 71 adapted, when a pulling force acts on the vibration-insulation fastener in the direction causing pullout from the stud, to stop the latch pawls which are slanted in a direction opposite to the pullout direction, and restrict the latch pawls in such a manner that the respective pawl edges of the pair of latch pawls engage with the stud even more tightly.

More specifically, one of the pair of latch pawls 65 is arranged to have a different height from that of the other latch pawl 65. Therefore, as shown in FIGS. 24 to 26, each of the block 70 and the block 71 is formed to have a different height to restrict the pair of latch pawls 65 in such a manner that the respective pawl edges 69 of the pair of latch pawls 65 simultaneously bite into and engage with the thread or groove of the stud. Thus, even if a force is applied in the direction causing pullout from the stud, the pair of latch pawls can evenly bite into the thread or groove of the stud to sufficiently resist the force causing pullout from the stud, so as to obtain a high fixing force. Further, when the pullout force is increased up to a level causing breakage of the latch pawls 65, the blocks 70, 71 allow all of the pairs of latch pawls to bite into the thread or groove of the stud while being evenly broken, so as to resist the pullout force. Particularly, in a threaded stud, while one of the pair of the latch pawls 65 bites obliquely into a spiral groove of a thread, the other opposed latch pawl bites into the spiral groove by the same biting force. This makes it possible to resist the pullout force. In order to allow each of the latch pawls 65 to be axially moved in a given allowable range, a gap is defined between each of the blocks 70, 71 and a corresponding one of the latch pawls 65.

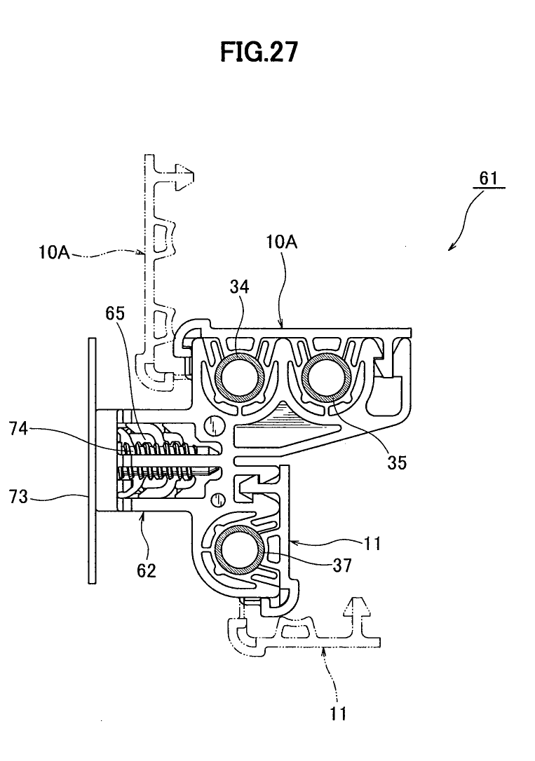

FIG. 27 shows a state after pipes 34, 35, 37 are held in the vibration-insulation fastener 61 while being coupled to each other, and the vibration-insulation fastener 61 is attached to a stud 74 fixed to a workpiece 73. The vibration-insulation fastener 61 can fix an elongated component, such as the pipes 34, 35, 37, to the workpiece 73, while preventing vibration transmission not only between the elongated components but also between the elongated components and the workpiece.

While preferred embodiments of the invention have been shown and described, it will be apparent that changes can be made without departing from the principles and spirit of the invention, the scope of which is defined in the following claims. For example, features of the various embodiments can be interchanged and modified. For instance, features of embodiments having covers that pivot to a closed position in the same direction can be used in embodiments having covers that pivot to a closed position in opposite directions, and vice-versa. The number of receiving members of the first clamps and the second clamps can vary, and not all of the same features may be used in each clamp of an embodiment. Thus different raised portion arrangements may be used in the clamps of an embodiment. Partial receiving members may be used in some of the clamps of an embodiment but not others. Partial receiving members may be used in conjunction with different types of raised portions and arrangements of raised portions. Where pipes alone are referred to in the description, it is to be understood that the pipes are representative of other elongated components.

What is claimed is:

1. An integrally molded plastic vibration-insulation fastener comprising:
a base;
a first clamp extending from the base and having a U-shaped receiving member with an opening facing a first direction for receiving an elongated component;
a second clamp extending from the base and having a U-shaped receiving member with an opening facing in a second direction for receiving an elongated component;
a first hinged cover moveable from an open position to a closed position at which the first cover closes the opening of the first clamp; and
a second hinged cover moveable from an open position to a closed position at which the second cover closes the opening of the second clamp,
wherein each U-shaped receiving member is spaced from a base part except at predetermined spaced regions where the U-shaped receiving member is connected to the base part, and
wherein each cover has a resilient pressing member disposed to engage an elongated component in a corresponding U-shaped receiving member when the cover is in the closed position.

2. An integrally molded plastic vibration-insulation fastener according to claim 1, wherein the first direction and the second direction are substantially perpendicular to one another.

3. An integrally molded plastic vibration-insulation fastener according to claim 2, wherein both of the covers turn clockwise or both turn counter-clockwise in moving from an open position to a closed position.

4. An integrally molded plastic vibration-insulation fastener according to claim 2, wherein one of the covers turns clockwise and the other cover turns counter-clockwise in moving from an open position to a closed position.

5. An integrally molded plastic vibration-insulation fastener according to claim 1, wherein at least one of the U-shaped receiving members is connected to a corresponding base part at a central region of its U-shape and at end regions of its U-shape.

6. An integrally molded plastic vibration-insulation fastener according to claim 1, wherein each cover has a latch mechanism for holding the cover in a closed position.

7. An integrally molded plastic vibration-insulation fastener according to claim 1, wherein at least one of the U-shaped receiving members has at least one protrusion projecting toward the corresponding base part in a space between the U-shaped receiving member and the corresponding base part.

8. An integrally molded plastic vibration-insulation fastener according to claim 7, wherein the protrusion is substantially T-shaped in cross-section with a central portion connected to the corresponding U-shaped receiving member and with ends adjacent to the corresponding base part.

9. An integrally molded plastic vibration-insulation fastener according to claim 8, wherein the corresponding base part has a protrusion extending toward the central portion of the T-shaped protrusion in the space between the U-shaped receiving member and the corresponding base part.

10. An integrally molded plastic vibration-insulation fastener according to claim 9, wherein the corresponding base part has protrusions extending toward the U-shaped receiving member at opposite ends of the T-shaped protrusion.

11. An integrally molded plastic vibration-insulation fastener according to claim 7, wherein such protrusions are provided in spaces between the U-shaped receiving member and the corresponding base part at opposite sides of the central region of the U-shaped receiving member.

12. An integrally molded plastic vibration-insulation fastener according to claim 1, wherein at least one of the U-shaped receiving members is bifurcated to provide a space at a central region thereof into which a projection from the corresponding base part extends to engage an elongated component in the U-shaped receiving member.

13. An integrally molded plastic vibration-insulation fastener according to claim 1, wherein the base has a stud receiver disposed between the first clamp and the second clamp.

14. An integrally molded plastic vibration-insulation fastener according to claim 13, wherein the stud receiver has a bore for insertion of a stud and wherein there is at least one pawl in the bore for engaging and holding the stud in the bore.

15. An integrally molded plastic vibration-insulation fastener according to claim 14, wherein there is a block in the bore for limiting movement of the pawl in a direction opposite to a direction of insertion of the stud in the bore.

16. An integrally molded plastic vibration-insulation fastener according to claim 1, wherein the first clamp is one of a pair of such clamps extending in parallel.

17. An integrally molded plastic vibration-insulation fastener comprising:
a base;
a clamp extending from the base and having a U-shaped receiving member with an opening for receiving an elongated component; and
a hinged cover moveable from an open position to a closed position at which the cover closes the opening;
wherein the fastener has a construction that suppresses transmission of vibration between an elongated component in the receiving member and the base and is devoid of vibration absorbing material softer than the molded plastic,
wherein, as part of said construction, the receiving member has a wall spaced from a base part, said wall being resiliently moveable into a space between said wall and the base part but having sufficient thickness to hold an elongated component in the receiving member, wherein end regions of said wall are connected to said base part by resilient reduced-thickness portions of said wall, and a central region of said wall is connected to said base part, and wherein said cover has a resilient pressing member disposed to engage said elongated component.

18. An integrally molded plastic vibration-insulation fastener according to claim 17, wherein said pressing member comprises a resilient U-shaped wall with legs extending obliquely from the cover and with the U-shaped wall surrounding an empty space.

19. An integrally molded plastic vibration-insulation fastener according to claim 17, wherein there is at least one protrusion in said space to limit movement of said wall into said space.

20. An integrally molded plastic vibration-insulation fastener according to claim 19, wherein a protrusion extends from wall toward the base part or from the base part toward the wall.

21. An integrally molded plastic vibration-insulation fastener according to claim 19, wherein a protrusion extends from said wall and is T-shaped in cross-section.

22. An integrally molded plastic vibration-insulation fastener according to claim 21, wherein there is a protrusion extending from the base part to a central portion of the T-shaped protrusion.

23. An integrally molded plastic vibration-insulation fastener according to claim 21, wherein said T-shaped protrusion has resilient arms.

24. An integrally molded plastic vibration-insulation fastener according to claim 23, wherein there are protrusions extending from the base part toward the ends of said arms.

25. An integrally molded plastic vibration-insulation fastener according to claim 17, wherein the receiving member is bifurcated to provide partial receiving members and a space at the central region of the receiving member and with the partial receiving members connected to the base part at the central region, and
wherein a projection extends from the base part into the space at the central region to limit movement of an elongated component in the receiving member toward the base part.

26. An integrally molded plastic vibration-insulation fastener according to claim 17, wherein there are splayed walls extending from the U-shaped receiving member to form a resilient tapered guide leading to said opening.

27. A fastener having a clamp for holding an elongated component and having a stud receiving portion with a bore for receiving a stud mounted on a workpiece,
wherein there are a plurality of pawls in the bore resiliently supported on a wall of the stud receiving portion and disposed to engage a stud in the bore, and
wherein the pawls are disposed at different positions along the bore, and there are blocks in the bore for limiting deflection of pawls in the bore in a stud release direction opposite to a stud insertion direction.
